(19) United States
(12) Patent Application Publication
(10) Pub. No.: US 2002/0172800 A1
(43) Pub. Date: Nov. 21, 2002

(54) Sheet member for making shoes, bags, coats or the like

(76) Inventor: Shui Mu Wang, Taichung Hsien (TW)

Correspondence Address: CHARLES E. BAXLEY, 5th Floor, 59 John Street, New York, NY, 10038, US

(21) Appl. No.: 09/861,494

(22) Filed: May 21, 2001

(51) Int. Cl. B32B 3/12

(52) U.S. Cl. 428/116

(57) ABSTRACT

A sheet member includes a base member having one or more protrusions extended from one surface for forming one or more recesses and for forming an uneven surface. A water proof covering member is attached onto the surface of the base member, in conformity with the uneven surface of the base member, for forming one or more protrusions and one or more recess in the covering member. The users may feel comfortable with the air permeable or air circulatable base member. The water proof covering member may prevent the products made by the sheet member from being dirtied.

### BACKGROUND OF THE INVENTION

1. Field of the Invention

The present invention relates to a sheet member or a pad member, and more particularly to a sheet member or a pad member for making shoes, bags, suitcases, coats, clothes, or the like.

2. Description of the Prior Art

Some of the typical shoe fronts, shoe rears, bags, suitcases, coats, clothes, or the like. are made of sheet members or pad members, such as the woven or non-woven materials, with which the users may feel comfortable, but may not be used as the water proof materials. The other shoe fronts, shoe rears, bags, suitcases, coats, clothes, or the like, are made of rubber or plastic sheet members that may be used as the water proof materials. But, the users may not feel comfortable when wearing the shoes or the clothes that are made of such water proof materials.

The present invention has arisen to mitigate and/or obviate the afore-described disadvantages of the conventional sheet members or pad members.

### SUMMARY OF THE INVENTION

The primary objective of the present invention is to provide a sheet member or a pad member including a water proof covering member engaged or attached onto a woven or non-woven base member, for forming a water proof member that the users may feel comfortable and that includes a water proof effect.

In accordance with one aspect of the invention, there is provided a sheet member comprising a base member including a first surface having at least one protrusion extended therefrom for forming at least one recess therein and for forming an uneven surface on the first surface of the base member, and a water proof covering member attached onto the first surface of the base member, in conformity with the uneven surface of the base member, for forming at least one protrusion and at least one recess therein. The sheet member thus includes a base member that is air permeable or air circulatable, such that the users may feel comfortable, and includes a water proof covering member that may prevent the products made by the sheet member from being dirtied. The covering member is preferably made of thermoplastic materials or the like that may be softened or melted and that may be solidly secured onto the first surface of the base member, in accordance with the uneven first surface of the base member when the covering member is heated or softened by the other devices.

The protrusion of the base member includes a honey comb shape, having the recess formed therein.

The base member includes a second surface, the sheet member further includes at least one second base member attached onto the second surface of the base member.

An adhesive material may further be provided and applied between the base member and the covering member for solidly securing the base member and the covering member together.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a sheet member or a pad member in accordance with the present invention;

FIG. 2 is a perspective view of the sheet member or the pad member;

FIG. 3 is an enlarged partial perspective and cross sectional view of the sheet member or the pad member;

FIG. 4 is a cross sectional view illustrating the other embodiment of the sheet member or the pad member;

FIG. 5 is a partial exploded and cross sectional view of the sheet member or the pad member as shown in FIG. 4; and

FIGS. 6, 7, 8, 9 are cross sectional and schematic views illustrating the formation or the manufacturing of the sheet member or the pad member in accordance with the present invention.

### DETAILED DESCRIPTION OF THE PREFERRED EMBODIMENT

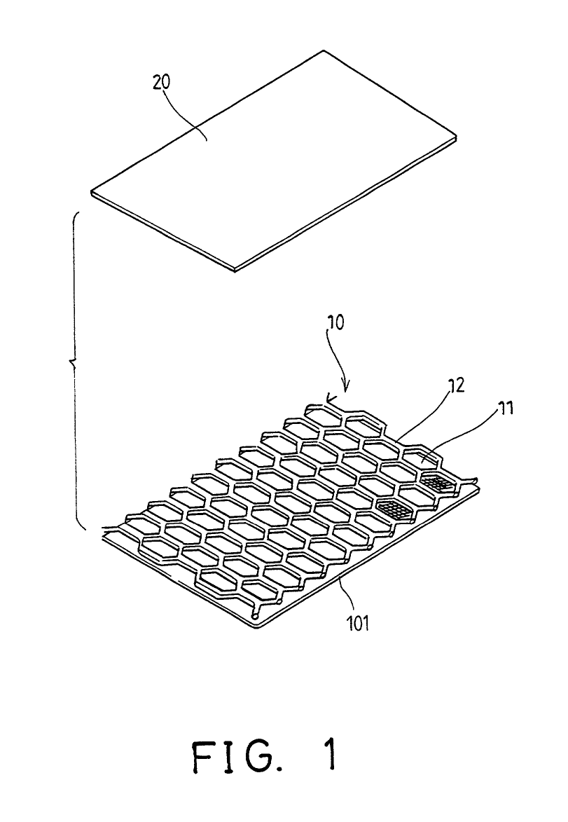

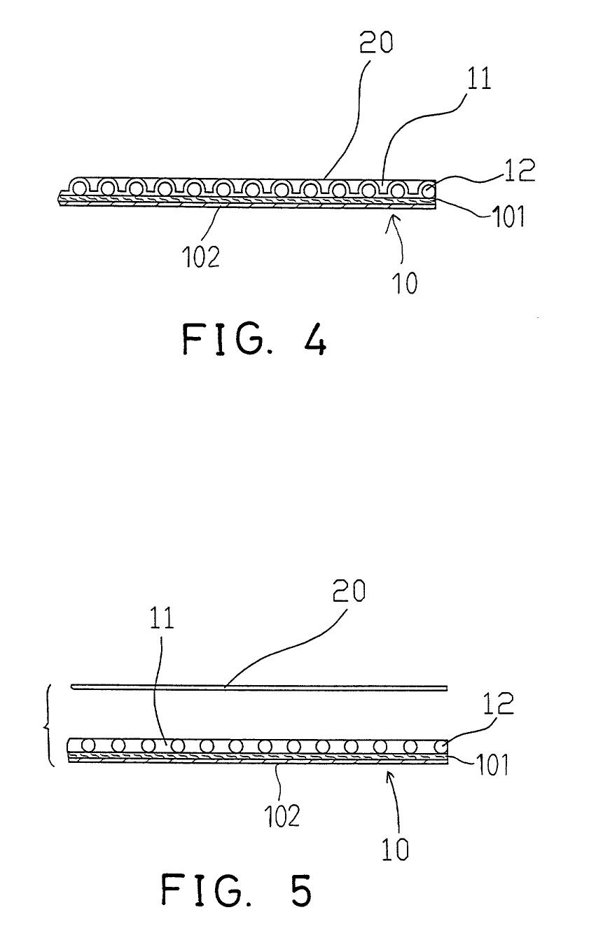

Referring to the drawings, and initially to FIGS. 1-3, a sheet member or a pad member 10 in accordance with the present invention comprises a base member 101 including a flat surface, such as a flat bottom surface, and including an opposite surface, such as the upper surface having one or more recesses 11 formed therein and formed or defined by one or more partitions or fences or ribs or protrusions 12 or the like. For example, the base member 101 includes one or more honey comb shaped protrusions 12 extended upward from the upper surface thereof for forming or defining the recesses 11 in the protrusions 12, such that the base member 101 includes an uneven upper surface. The base member 101 and/or the protrusions 12 of the base member 101 are preferably formed by the woven or non-woven materials that are air permeable or air circulatable, and may be formed by superposing two or more wires or threads or the like, or may be formed by engaging longitudinal wires or cables or threads into the woven or non-woven materials for forming the protrusions 12 in the base member 101. As shown in FIGS. 4 and 5, the sheet member 10 may include one or more base members 101, 102 formed or provided therein.

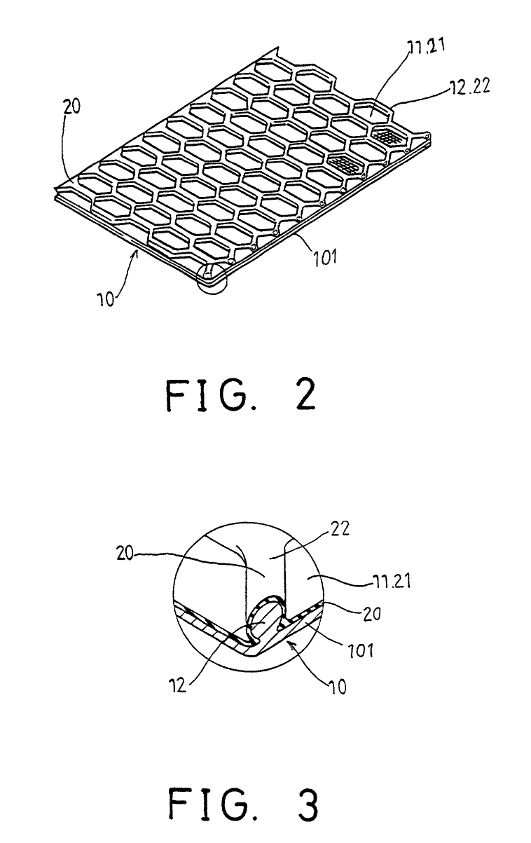

The sheet member 10 further includes a water proof covering member 20 attached or engaged onto the base member 101, and preferably made of thermosetting or thermoplastic materials, or luminous membranes or films, or reflective membranes or films, etc., which may be softened by heat and which may be engaged onto the uneven upper surface of the base member 101 in accordance with the uneven upper surface of the base member 101, such that the water proof covering member 20 also includes one or more recesses 21 formed therein and formed or defined by one or more partitions or fences or ribs or protrusions 22 or the like. For example, as shown in FIGS. 2-4, the water proof covering member 20 includes one or more honey comb shaped protrusions 22 extended or formed thereon for forming or defining the recesses 21 in the protrusions 22, such that the water proof covering member 20 also includes an uneven outer surface.

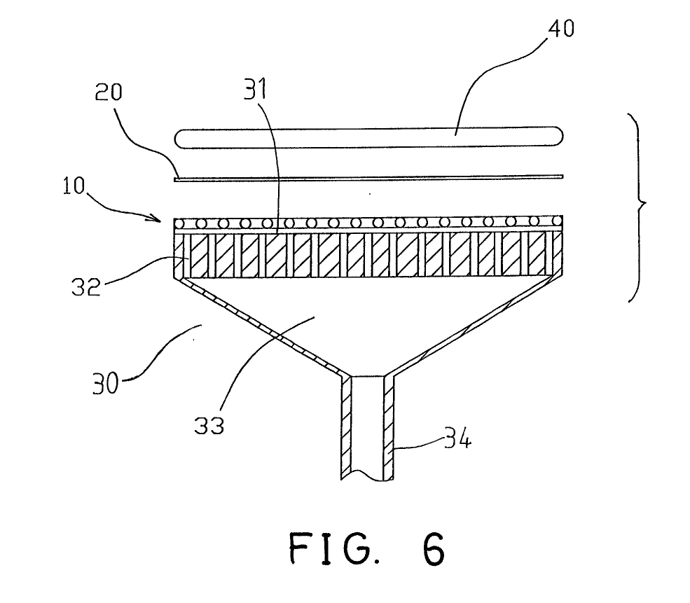

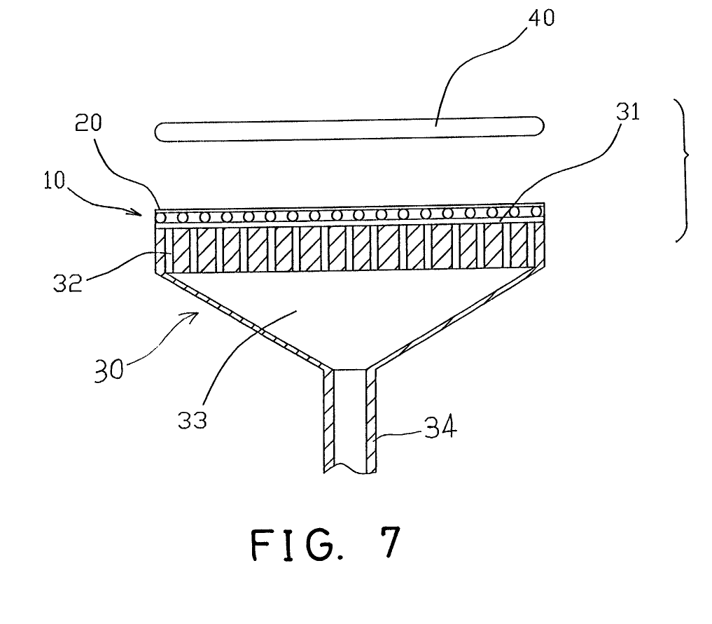

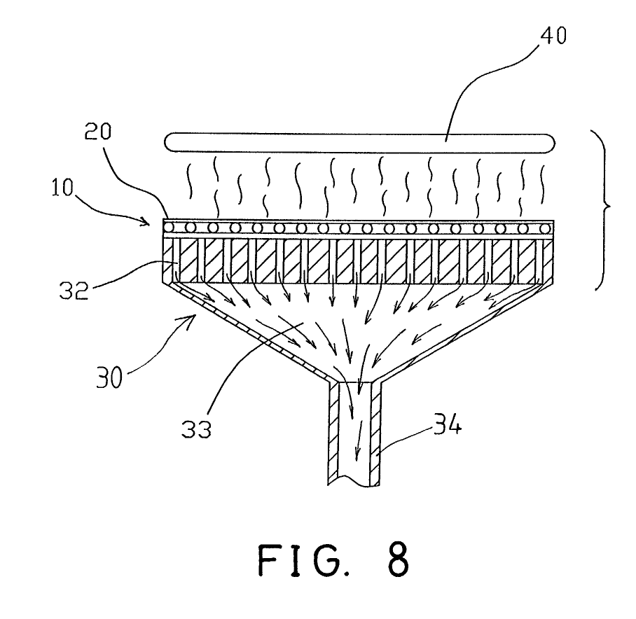

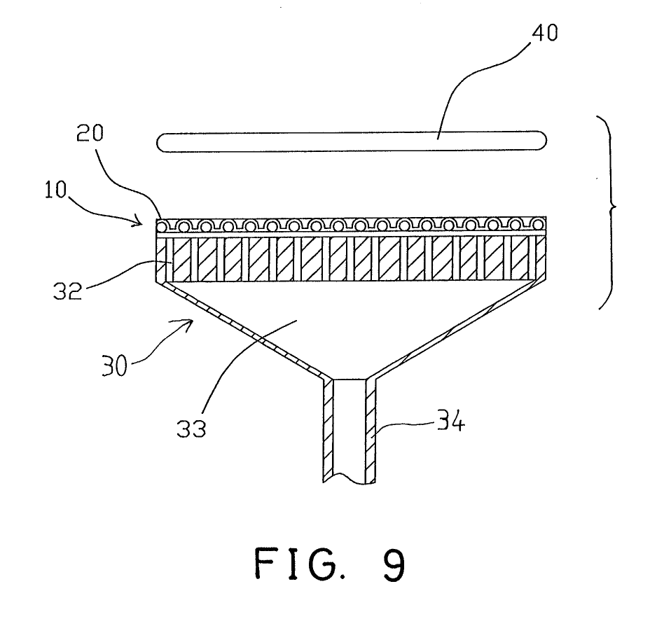

Referring next to FIGS. 6-9, illustrated is a mold device 30 for forming or manufacturing the sheet member 10 in accordance with the present invention. The mold device 30 includes an upper portion 31 having one or more orifices 32 formed therein, a chamber 33 formed in the middle portion thereof and communicating with the orifices 32 thereof, and a port 34 coupled to a vacuum pump or the like, for vacuuming the mold device 30 and for drawing and securing the base member 101 on the upper portion 31 of the mold device 30. A heat device 40, such as a heating tube or the like, is disposed above the mold device 30, for heating or softening the covering member 20 that is disposed above the base member 101 and that may be adhered onto or secured onto the upper portion of the base member 101 according to or in accordance with the uneven upper surface of the base member 101.

It is to be noted that the covering member 20 may be softened or melted and thus secured onto the base member 101 by the adhesive characteristic of the covering member 20 itself. Or, an adhesive material may be applied onto the upper surface of the base member 101, or onto the lower surface of the covering member 20, for adhering and securing the covering member 20 on the base member 101. The base member 101 is air permeable or air circulatable, such that the covering member 20 may be solidly drawn and secured onto the base member 101 when the mold device 30 is vacuumed. The covering member 20 may thus be solidly secured onto the base member 101 in accordance with or in conformity with the uneven upper surface of the base member 101.

The sheet member in accordance with the present invention thus includes a water proof covering member 20 engaged or attached onto the woven or non-woven and/or air permeable or air circulatable base member 101, for forming a water proof sheet member 10 that the users may feel comfortable. The sheet member 10 may be used for making the shoe members, the shoe fronts, the shoe rears, the bags, the suitcases, the coats, the clothes, or the like. The base member 101, 102 and/or the covering member 20 may be formed with conductive materials, or may be woven by conductive wires or cables or the like, for anti-static electricity purposes.

Accordingly, the sheet member or the pad member in accordance with the present invention includes a water proof covering member engaged or attached onto a woven or non-woven base member, for forming a water proof member that the users may feel comfortable and that includes a water proof effect.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sheet member comprising:
a base member including a first surface having at least one protrusion extended therefrom for forming at least one recess therein and for forming an uneven surface on said first surface of said base member, and
a water proof covering member attached onto said first surface of said base member, in conformity with said uneven surface of said base member, for forming at least one protrusion and at least one recess therein.

2. The sheet member according to claim 1, wherein said at least one protrusion of said base member includes a honey comb shape, having said at least one recess formed therein.

3. The sheet member according to claim 1, wherein said base member includes a second surface, said sheet member further includes at least one second base member attached onto said second surface of said base member.

4. The sheet member according to claim 1 further comprising an adhesive material applied between said base member and said covering member for securing said base member and said covering member together.

5. The sheet member according to claim 1, wherein said covering member is a reflective membrane.

6. The sheet member according to claim 1, wherein said covering member is a luminous membrane.

7. The sheet member according to claim 1, wherein said covering member is made of conductive member.

8. The sheet member according to claim 1, wherein said base member is made of conductive member.

9. The sheet member according to claim 1, wherein said base member is made of conductive wires.

10. The sheet member according to claim 1, wherein said base member includes a plurality of woven conductive wires.
